(19) United States
(12) Patent Application Publication
(10) Pub. No.: US 2011/0238762 A1
(43) Pub. Date: Sep. 29, 2011

(54) GEO-CODED COMMENTS IN A MESSAGING SERVICE

(75) Inventors: Punit Soni, San Francisco, CA (US); Steven J. Lee, San Francisco, CA (US); Sanjay Mavinkurve, East Palo Alto, CA (US); Fred Gilbert, Mountain View, CA (US); Carlos E. Whitt, San Francisco, CA (US); Ana Maria Ulin Vazquez, Palo Alto, CA (US); Li-Wei Lee, New York, NY (US); Marc Peter Tarca Wilson, London (GB); Mathieu P. Balez, San Francisco, CA (US); Aleksandr V. Kennberg, Waterloo (CA)

(73) Assignee: GOOGLE INC., Mountain View, CA (US)

(21) Appl. No.: 13/023,877

(22) Filed: Feb. 9, 2011

Related U.S. Application Data
(60) Provisional application No. 61/302,949, filed on Feb. 9, 2010.

(51) Int. Cl. G06F 15/16

(52) U.S. Cl. 709/206

(57) ABSTRACT

Some techniques feature a computer-implemented method for messages associated with a user location. The method involves determining, by a mobile computing device, an estimated geographic location of the mobile computing device. The method includes receiving, at the mobile computing device, one or more messages associated with an area within the estimated geographic location, where the one or more messages include messages posted by users of a system that associates messages that those users posted about the area within the estimated geographic location. The method involves providing, on a display of the mobile computing device, one or more posted message icons that are presented in a layer over a map, where the one or more posted message icons represent the one or more posted messages. In a system, the one or more posted messages may not appear on mobile devices after a predetermined amount of time from their respective postings.

### CROSS-REFERENCE TO RELATED APPLICATIONS

This application is a utility application that claims priority to U.S. Provisional Application Ser. No. 61/302,949, filed on Feb. 9, 2010, the contents of which are incorporated by reference.

### TECHNICAL FIELD

This document generally describes techniques, methods, systems, and mechanisms for posting real-time messages about a venue or user location.

### BACKGROUND

People use mobile computing devices for many applications, including for communicating with friends and for receiving information about the world. For example, a mobile device user may find restaurants in the user's current immediate area that serve a certain type of food, and may also review comments posted by other users about the various restaurants.

Mobile computing devices, such as cell phones, can use location-identification systems (e.g., global positioning system, GPS) to determine an estimated geographic location of such devices. Using an estimated location sent from a device, a system may be able to identify venues (e.g., commercial businesses) that are located near the estimated geographic location of the device.

### SUMMARY

This document describes techniques, methods, systems, and mechanisms for managing comments that are submitted to a subscription-based messaging service (e.g., Twitter, Inc. of San Francisco, Calif.) that are layered on a map based on a location or venue to which each comment is tied (e.g., a GPS location of the phone or a user-selected business). The user can view comments related to multiple locations on the map. The map can be two dimensional (2D) or three dimensional (3D) (e.g., augmented reality). Selection of a business, company, or a venue/location can enable a user to view comments that are specific to the business, for example.

In general, a user of an application telephone may use a micro-blogging application to submit short textual posts to a micro-blogging service. The posts may be transmitted from the mobile computing device to a central server where the posts are disseminated to computing devices of other people, including other people who have previously indicated an interest in “following” the posting user, and who thus receive notices of new posts, such as in a stream presented to them on their computing devices. These other people may view the posts by using the same micro-blogging application or logging into a website that displays a stream of posts by other people that use the micro-blogging service. In particular, some people may “follow” or subscribe to the user, so that these other people receive the user's posts. Also, posts by the user that happen to be highly rated by automated algorithms (e.g., based on views or ratings) can be provided to other people that do not “follow” the user. These other people may be “friends of friends” of the user, or otherwise in a related association in a social network graph.

Some aspects of this disclosure feature a computer-implemented method for real-time messages associated with a user location. The method involves determining, by a mobile computing device, an estimated geographic location of the mobile computing device, and receiving, at the mobile computing device, one or more messages associated with an area around the estimated geographic location. The one or more messages involve messages posted by users of a system that associates messages that those users posted about the area around the estimated geographic location. The method also includes providing, on a display of the mobile computing device, one or more posted message icons that are presented together in a layer over a map, where the one or more posted message icons represent the one or more posted messages.

These and other implementations can optionally include one or more of the following features. The area can include a venue, a business, a street, or an address, among others. The computer-implemented method can involve receiving a user input of a selection of one of the posted message icons to present information associated with the posted message associated with the posted message icon, and obtaining information about the posted message from a server system. The computer-implemented method can involve, in response to receiving the user input of the selection of the posted message icon, presenting information for the posted message. The information for the posted message can include a user text message, a user identification (ID), and at least one of a time of the posting of the message or a day of the posting of the message. The information for the posted message can include a picture corresponding to the user identification (ID). The information for the posted message can include a user-provided picture. The one or more posted message icons that are presented in the layer over the map can be one or more posted messages that were posted within a predetermined time period of their respective postings. The predetermined time period can be 24 hours, and the one or more posted message icons can be removed from the layer over the map after the predetermined time period expires. The computer-implemented method can include presenting a selectable icon that, when selected, presents a selectable list of the one or more posted messages. The computer-implemented method may involve receiving a user input, at the mobile computing device, for composing a message to post to at least one other user, as well as receiving, at the mobile computing device, the composed message to post, and posting, from the mobile computing device, the composed message to a server system.

In other aspects, a computer-implemented method for managing real-time messages associated with a user location involves receiving, at a mobile computing device, one or more messages associated with an area within a geographic location, where the one or more messages involve messages posted by users of a system that associates messages that those users posted about an area within a geographic location. The method involves providing, on a display of the mobile computing device, one or more posted message icons that are presented in a layer over another layer in the display, where the one or more posted message icons represent the one or more posted messages. The method also involves receiving, at the mobile computing device, a user input of a selection of one of the posted message icons to present information associated with the posted message associated with the posted message icon, and presenting, on the mobile computing device, the information associated with the posted message on the display of the mobile computing device.

These and other implementations can optionally include one or more of the following features. The other layer can include a venue layer, a satellite layer, a map, a two-dimensional rendering of the area, a three-dimensional rendering of the area, a street view layer, or an augmented reality layer. At least one of the other layers can be configured to be overlaid on top of at least one of the other layers, and one or more of the other layers can be configured to be toggled on or off by a user selection on the mobile computing device. The computer-implemented method can also involve receiving user input on the mobile computing device to subscribe to compose a message for posting. The computer-implemented method can involve receiving user input on the mobile computing device to present a list of venues; and based upon the receiving user input for the list of venues, presenting a list of venues on the mobile computing device. The computer-implemented method may also involve receiving user input on the mobile computing device to present information associated with one or more posted messages of a selected venue in the list of venues, and based upon receiving the user input for the venue selection, presenting the information associated with the one or more posted messages of the selected venue. The information associated with the posted message on the display of the mobile computing device can include venue information. The method can include receiving a user input, at the mobile computing device, regarding the venue information, and presenting the venue information in an interface on the mobile computing device. The presented venue information can include a list of posted messages associated with the venue. One or more of the posted messages in the list of posted messages can be deleted from the list if the posted message has been listed over a predetermined amount of time. A new posted message can appear in the list of posted messages when a subscriber of the system posts the new posted message.

Other aspects involve a system for real-time messages associated a user location. The system includes a mobile computing device configured to receive one or more messages associated with an area within an estimated geographic location, where the one or more messages include messages posted by users of the system to associate messages that those users posted about the area within the estimated geographic location. The mobile computing device is also configured to provide one or more posted message icons that are presented in a layer over a map, where the one or more posted message icons represent the one or more posted messages. The system includes a location-identification unit to determine the estimated geographic location of the mobile computing device, and a server to receive the estimated geographic location and forward the one or more posted messages associated with the area to the mobile computing device.

The details of one or more embodiments are set forth in the accompanying drawings and the description below. Other features, objects, and advantages will be apparent from the description and drawings and from the claims.

### DESCRIPTION OF DRAWINGS

FIG. 1A is a diagram of a system for presenting layered communication information on a mobile computing device.

FIG. 1B is a schematic diagram of a system within which the various features described in this document may be implemented.

FIGS. 1C-1D illustrate a presentation and selection of a suggested location of a mobile device running a micro-blogging application.

FIGS. 2A-2E illustrate a selection of a location of the mobile device.

FIG. 3A is an illustration of posted comments about one or more locations presented on the mobile device.

FIGS. 3B-3C show illustrations involving posted comments associated with the venue.

FIG. 4A is a flowchart of an example process for verifying a venue associated with a user location.

FIG. 4B is a flowchart of an example process for receiving or sending a posting of a message.

FIG. 5 is a flowchart of an example diagram illustrating other types of postings using the layer of the message overlay.

FIG. 6 is a block diagram of an example system for the postings.

FIG. 7 is a diagram of computing devices that may be used to implement the described systems and methods, as either a client or as a server or plurality of servers.

Like reference symbols in the various drawings indicate like elements.

### DETAILED DESCRIPTION

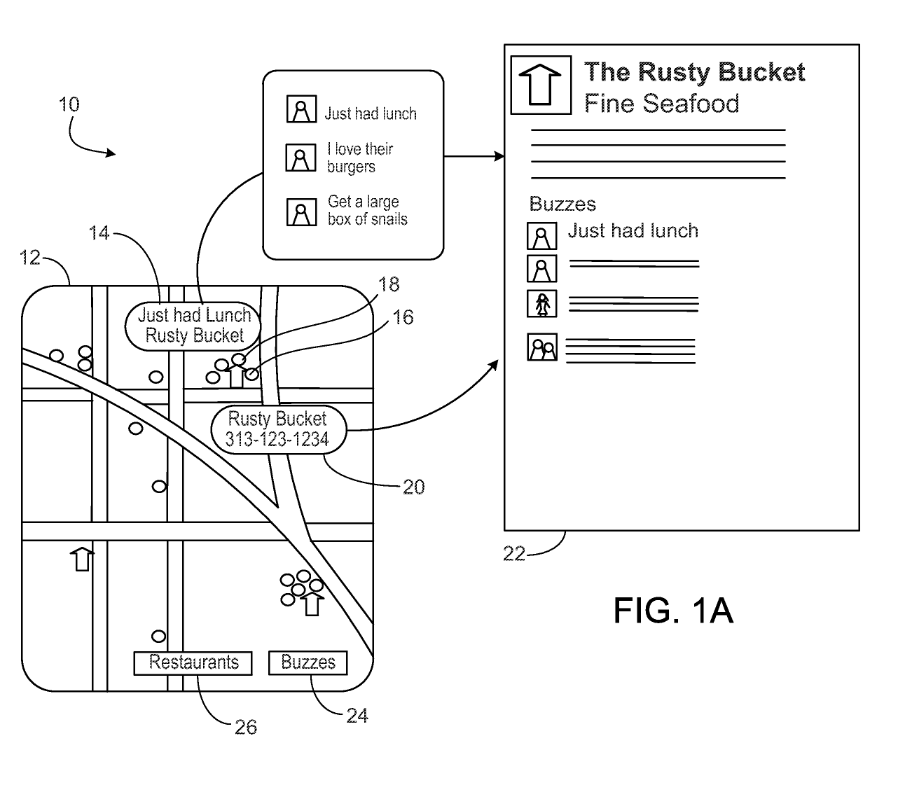

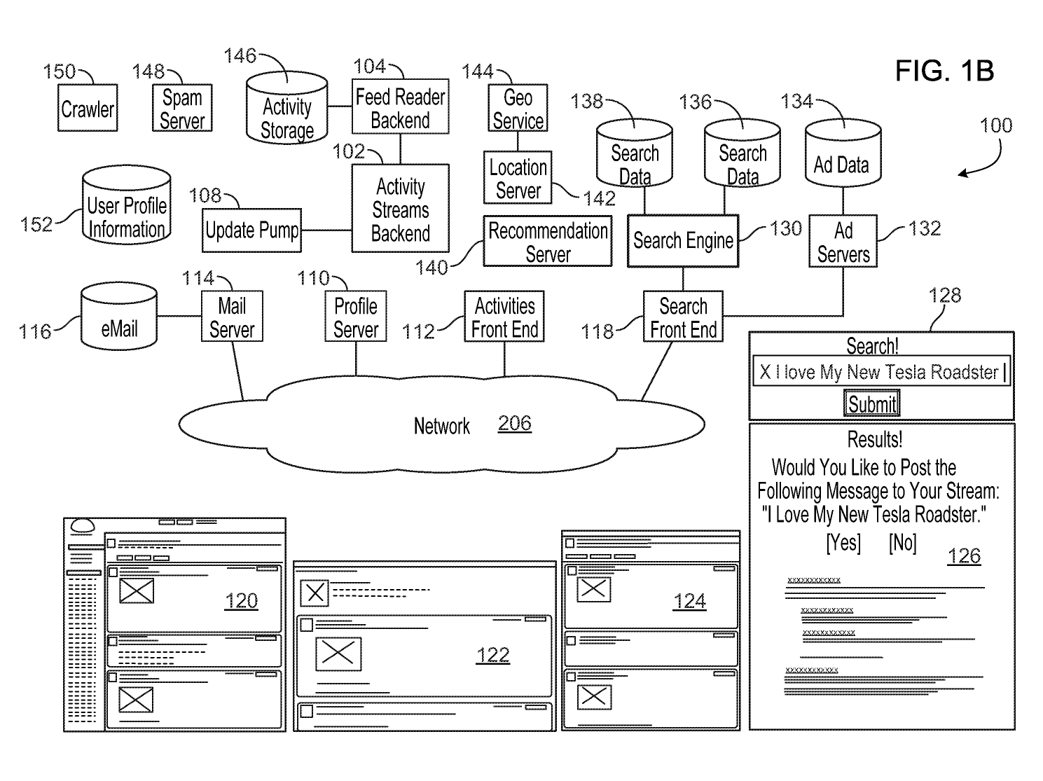

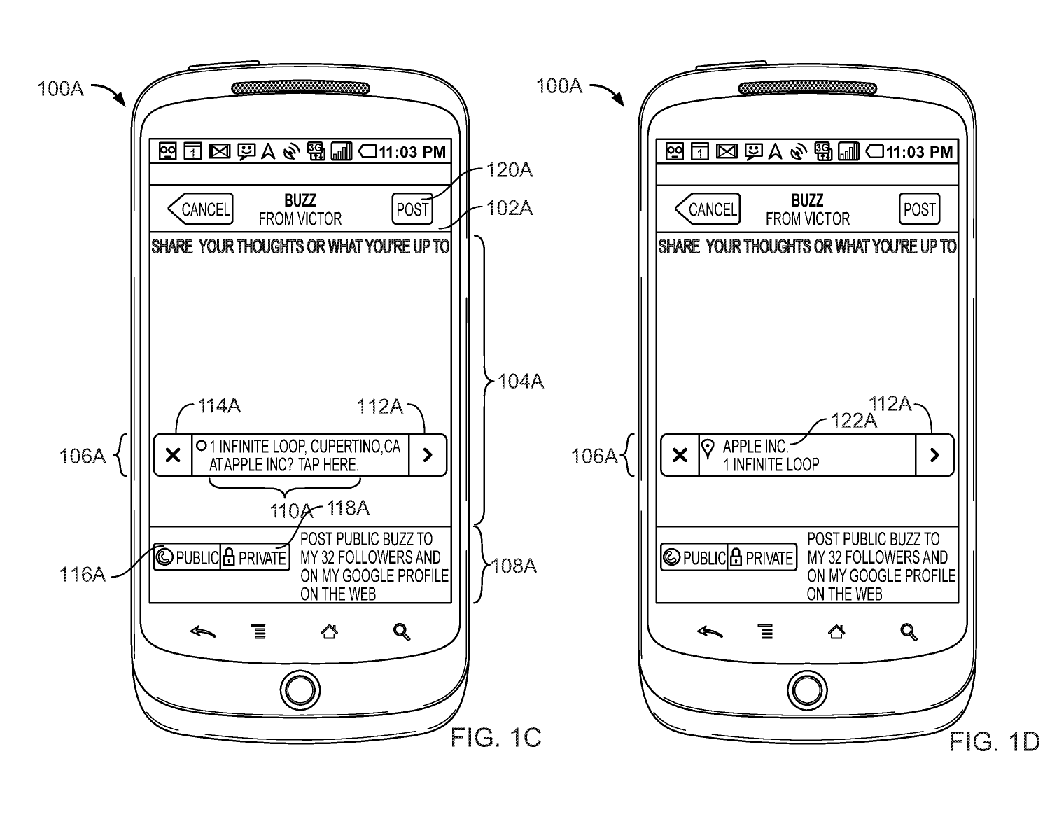

FIG. 1A is a diagram of a system 10 for presenting layered communication information on a mobile computing device. In general, the figure shows an example display 12 of a mobile computing device that shows a map of an area around a user of the device, or an area to which the user intends to travel. The map is overlaid with different information that may be provided in discrete information layers, and a user can select certain icons on one of those layers to see information about geo-located posts that other users have made to the system 10.

For example, the display 12 shows an icon of a building 16 on the map, where the building is a restaurant that I registered with he system, so that it has its own profile page 22 that the system 10 can display to the public. The restaurant is displayed, along with icons for two other restaurants, because the user of the device has turned on a restaurants layer on their device, e.g., using control 26.

The display 12 also shows a number of round dot icons, such as icon 18. These icons each represent a geo-located post that has been made by another user of the system. Both of the types of icons are relatively small and do not convey much information, so as to minimize the amount of clutter on the display 12, since a large number of such icons may need to be displayed.

The figure further shows mechanisms by which users can obtain more information about the restaurant 16 or posts associated with the restaurant. Such posts may have been initially associated directly with the restaurant by the system using location information generated by the posting devices (e.g., GPS data) and then asking the users of such devices to conform the venues from which they were posting. In one example, a user make click on the restaurant 16 to raise a pop-up bubble 20 that shows general information about the restaurant, such as its name and telephone number. If the user is interested (e.g., the name looks good to the user), the user may select one of the elements in the buddle 20 to be presented with the profile page 22 for the restaurant. The profile page may include general information about the restaurant, such as photos of the interior of the restaurant and its dishes, the telephone number, address, and directions to the restaurant, and reviews of the restaurant. Also, the profile page 22 may present various posts (and related streams) that have been associated with the restaurant, such as by users identifying the restaurant as their current venue when they post messages to a service.

The restaurants profile page may also be reached in this example by an alternative route. In particular, a user can select icon 18 to raise a pop-up bubble 14 that display some or all of the text of a posting that was made from a user who identified their venue as being the restaurant. Other similar pop-up bubbles may be raised by dragging a pointer over other similar icons on the display 12.

Selection of certain items in the pop-up bubble may in turn raise a page (which may be overlaid on the map) that shows the entire stream corresponding to the initial post. In particular, here, two friends of the original posting user have commented on the post. Further selections by a user may then lead to the restaurant's profile page 22. For example, a name of the restaurant ma be displayed on the intermediate page (not shown), and the name may be a hyperlink that leads to the profile page 22.

The information that is presented on the map may be affected in ways in addition to user activation of various layers. The posts that are displayed may also be filtered by a user in various manners. For example, a user may wish to see only posts from other users that the first user has affirmatively elected to “follow.” The user may also see time-filtered posts, such as by selecting a graphical slider that can be displayed on their device, so that they see only posts in the last x hours or y days. The user can also choose to see icons only for posts that have been ranked higher than a desired level by other users (e.g., 3 stars or above on a scale of 5).

Thus, by these mechanisms, a user of a computing device may be presented with geo-coded messages posted by other users (e.g. to whom the first user has subscribed), in an overlay layer on a geographic map. The user of the computing device may also conveniently access the text of the messages, and may then obtain even more additional information about the subjects of the messages (such as venues).

FIG. 1B is a schematic diagram of a system 100 within which the various features described in this document may be implemented. In general, the system 100 permits various users to post, review, and comment on various activity streams of information, within a social networking framework. For example, a user may make a micro-blogging post about a recent happening in the user's life or about a news article the user recently read. That post may be forwarded to other users who have chosen to follow or are otherwise linked to the first user (who may be an individual or an organization). Those other users may see the post using a stream reader, or the post may be displayed in their email applications (e.g. either in line with their regular email messages or under a separate tab). Those users may choose to comment on the post, and other users may also comment on the post or comment on the comments of other users. Such comments may be included and shown in the various user email applications even if they were made after the post was originally connected to the email application. Thus, the various types of feedback may be made available to each user conveniently in one place. Users may also see posts related to other users by visiting profile pages for those other users, and may also go to their own profile pages or to their stream pages to see all of the posts and comments for posts to which they are subscribed. In some embodiments, users do not need or require a subscription but can access the posts of various users for areas where those users have made a post.

The various posts, and comments on posts, are managed in the system 100 by an activity streams backend 102, which is in charge of implementing business logic that defines the manner in which various submissions to the system 100 will be handled. The activity streams are characterized by activities, which are the subjects of posts (e.g., micro-blog posts) that users submit to the system 100, and various comments directed toward those activities. For example, a user may post an activity regarding a web page they are currently viewing by pasting a URL of the page into a posting page. Such action may cause the system 100 to gather important information from the URL, including images displayed on the page, headings, labels for images, or topical terms that describe a topic of the page (e.g., as previously determined by analysis of the words on the page, such as using ADSENSE analysis of the page). The system 100 may also obtain location information, such as the current location of the user, and/or a venue with which the user is most currently associated (e.g., that the user checked into recently or identified as a venue in which the user is located).

The activity streams back end 102 also implements logic for determining what users are to receive posts, comments on posts, and other portions of streams in the system 100. In particular, users who have subscribed to receive posts from other users may be provided with posts when they log into the system 100, users may nominate other users to receive copies of streams when those other users would not ordinarily be included in the streams (e.g., by typing in identifiers for those other users when reviewing a post), and users may send streams directly to each other, among other things.

The feed reader back end 104 manages storage of posts and related data for the system 100. The feed reader back end 104 may rely on various levels of activity storage 146 to store posts, comments on posts, and other information needed to construct streams for users when they request information from system 100. As with the other components shown in this figure, the feed reader back end 104, though shown as a single block, can be implemented using a number of different servers or server sub-systems. Likewise, the activity storage 146 can be implemented across a number of databases and database types and across a variety of servers and server sub-systems.

When posts or other updates are received by the activity stream back-end 102, they are formatted and provided to update pump 108. The update pump 108 is responsible for providing notices about newly-posted information to various services that may need such information. It can act, in effect, as a router and distributor of information relating to the system 100. For example, a mail server 114 may include functionality for integrating the display of streams, and may thus need to know about new posts so that users of a mail client can be shown immediately when new information is posted. In a similar manner, a search engine 130 may provide search results to users that include real-time updating information from various posts that users are supplying to the system, and can receive such updated information by interacting with the update pump 108 via understood application programming interfaces (APIs) and remote procedure calls (RPCs) where the two components are sub-components of a larger organization-wide system.

Various web front-ends are provided to permit the system 100 communicate over a network 106, such as the internet (and adjacent supporting networks). For example, the mail server 114 may provide typical web-based electronic mail functionality, though with the integration of posts and comments into users' inboxes, via a mail client 120. For example, streams may show up as discrete messages in a user's inbox, and may be updated in real time to include the latest comments on the streams and originating posts for the streams. Such content may be active, in that a user may be allowed to interact with it substantially to a level that they could if they were reviewing the streams in a dedicated stream reader. For example, selectable controls may be provided with a stream that is displayed by the mail client 120, and a user may choose one in order to post a comment to be added to a stream, without having to leave the context of the message within the mail client 120.

A profile server 110 generates code for representing user profiles such as profile 122 of user Joe Blow. The profile page may take the form of a standard feed page from a social networking site, arranged with a list of posts and comments from other users in reverse chronological order. In a similar manner, an activities front end 112 can generate a similar feed for a user's feed page 124, here for a user named Susie User. The profile page 122 and the feed page 124 may be very similar to each other, and can present content similar to that presented as part of a posting or micro-blogging section of mail client 120. In one example, the profile page 122 is what third parties see when they look at the user's account, while the feed page 124 is what the user himself or herself sees.

A search engine 130 and associated search front end 118 may provide a different sort of functionality for the system 100. Specifically, the search front end 118 may allow users to provide posts or comments from non-traditional sources, such as search boxes, e.g., on a search web page or in a search box on a toolbar installed on their machines an operating in concert with their web browsers. Such posts or comments may be submitted by users and may be received by the search front end in a standard manner, just as search requests are. The intent of a user to submit a post rather than a search query (or in addition to a search query) may be determined by syntactical analysis of the submission. In one example, if a query is preceded by the letter “z”, with a space after it (see screen 128)—a construct that is seldom submitted as a real search query —the system may parse the submission apart and assume, from the syntax, that the user intends to post the remainder of the submitted query as a post to their social network.

Such a post may be made immediately or after confirming with the submitting user that they would like to make a posting. For example, a search results page 126 may be generated that contains actual search results for the submitted query (whether with or without the preceding “z”) generated by the search engine 130 using data from index 138 in a conventional manner, and may be displayed below an area that shows the user the form of a proposed post and selectable controls by which the user can edit the post and can then confirm an intent to post the information to friends, followers, or others. The post may then be forwarded by the search front end 118 to the activity streams backend 102, along with identifying information for the user (e.g., a user ID identified from a cookie on the user's computing device when the user is logged onto a broader service that implements the system 100).

Other syntax submitted by a user may produce different results. For example, if a user enters an email address (e.g., of the form “name@domain.com”), the system may identify that syntax as indicating an intent to send the remaining text of the submission as an email message to the user at the provided email address. Likewise, if the user starts a submission with a control character followed by a communication mode identifier, the remainder of the submission may be submitted for posting in that communication mode, either with or without first presenting the proposed action to the user and confirm that the user intends such a communication to occur. For example, if a user types “z blog I'm having a great time,” the syntax may indicate to the system 100 that the user would like to post the submitted phrase “I′m having a good time” to the user's blog (where the identity of the blog may be determined by the system 100 using a user ID stored as a cookie on the user's computing device, and which can be correlated to an account for the user that is in turn correlated to the blog).

The search results and other information (e.g., posts and email messages) may be accompanied by targeted advertisements directed to the search query or other similar information, such as profile information, the text of posts or comments by a user, the text of posts or comments of users who have a relationship with a user (e.g., as friends, followers, or users that the first user follows). Such advertisements may be served, through the search front end 118, or the other front ends 110, 112, 114 to users of the system 100 and may be targeted using techniques like those employed in GOOGLE ADWORDS OR ADSENSE. Such serving of advertisements may depend on ad data in database 134, which may include information about advertisers, the text and other content for the advertisements, bid prices submitted by the various advertisers, and other relevant information needed to serve advertisements that are directed to users and/or streams of information directed from or to the users.

Various location-based services may be integrated with posts or comments, such as by identifying the locations (e.g., lat/long coordinates) or venues (e.g., stores, arenas, bars, or restaurants) from which posts or comments are made. Such services are provided in this example system 100 by a location server 142 and geo service 144. The location server 142 generally provides information about venues or other landmarks in response to receiving location information about a user of system 100. For example, when a user submits a post, geo-coordinates for the user may be provided with the post (e.g., via GPS functionality on the user's mobile computing device) or may be determined for the user by the system 100 (e.g., via cell tower or access point identification or triangulation). The geo-location information may be an estimated latitude and longitude of the mobile computing device and information identifying an accuracy of the estimation. The location server 142 may be made available through an API to various other components of the system 100.

The location server 142 may use such geo-location information to identify one or more venues (e.g., stores, restaurants, or bars) in the general location of the user, may use proximity of the user to each venue and other signals (e.g., popularity of each venue as determined from search queries submitted with the venue name, check-ins at the venue by users of the system 100, a volume of activity associated with posts from the venue, a reputation of a post's author, for example, through number of subscribers, a volume of comments on posts, or a similarly determined reputation of the subscribers) to provide a ranked list of venues in the geographic area that the user may be located. The user may be presented with a single suggestion for a venue or several suggested venues. The user may then select one such venue, and that venue may be associated with the post when other users review it. For example, the post may be accompanied by meta data indicating that the post was “Posted from Dive Bar,” and other users may select the name “Dive Bar” to see additional information about the venue, including other posts from the venue, ratings of the venue, streams that belong to the venue (e.g., if a manager of the venue has made the venue a user of the system 100) and other similar information.

The location server 142 may obtain information that it needs to provide such functionality from various external services, such as geo service 144. Geo service 144 may be a service that communicates via standard APIs to receive location information (e.g., lat/long coordinates) and to provide more advanced information in response. The more advanced information may include a street address that is determined to be associated with the lat/long coordinates (e.g., a street address that is nearest to a particular location represented by the lat/long coordinates). The more advance information may also include a list of venue names that are geographically near the particular location, street addresses for the venues, descriptive information for the venues, map tiles that are associated with the particular location, and a relevance score for each venue. The relevance score for each venue may identify how relevant the particular venue is based on any combination of (i) the received location information, (ii) an accuracy of the received location information, and (iii) a distance between the venue and a location identified by the received location information.

Other components may interact with the components already described to provide additional functionality for the system 100. For example, a crawler 150 may crawl various posts and comments for the purpose of indexing the content in the system 100, so that, for example, search engine 130 may readily deliver search results that include the latest postings by users to the system 100. Also, spam server 148 may communicate with the activity streams backend 102 and/or the update pump 108 to identify posts or comments that may be inappropriate (e.g., offensive, abusive, or otherwise inappropriate), duplicative, deceptive (e.g., in which one user poses as another user), and to act appropriately with respect to such content (e.g., providing for automatic and/or manual review of the content and perhaps removing the content from the system 100 or making the content hidden).

Finally, a recommendation server 140 may be provided with any new activity or post that is submitted to the system 100 (e.g., via the activity streams back end 102). The recommendation server 140 may write back to the activity streams backend 102 about the number of people who should receive the activity. Such information may be saved so that the next time a message is sent out about the activity (e.g., a comment on the activity) the new recommended users also get the activity. A quality score can be computed when determining what users should receive an activity, and the score can be determined by factors such as the distance of relationship between a user and other users who have posted to or recommended an activity, interests of a user as identified in the user's profile (e.g., the user is a member of a classic cars group in a social network, and thus is more likely to receive notices about activities relating to classic cars), or interests as identified by posts or other submissions that the user makes, users or activities that the user follows, and the like. A quality threshold may be set by the recommendation server 140 in order to maintain an adequate level of recommendations (e.g., not too many and not too few).

Using the components described here, then, the system 100 may provided for integration of various modes of posting and receiving content that is provided in streams, such as micro-blog posts and comments on such posts. Users may post in various ways, including directly into search boxes on search pages or toolbars, so that such users may be more tightly integrated into systems provided by the providers of the pages or toolbars, and may provide posts in contexts with which they are already very familiar. Also, the users may review posts and other content in their email client, also in a manner that is already familiar to them and does not require them to leave a familiar application in order to review such posts. Moreover, the content may be rich for the users, such that it may include information about locations and venues at those locations (from which a reader of the content may obtain additional information, such as from hyperlinks provided in posts), and the users may respond to posts in-line, such as from their email applications. In all these ways the system 100 may provide a communication facility that allows a user simpler and more complete interaction with friends and with other users, and may increase the level of knowledge that is made available to the users of the system 100.

Some aspects of this disclosure generally describes providing a real-time post related to a venue of user location, receiving user verification of the suggested venue, and switching between location contexts. The venue may represent a particular map point, boundary, landmark, business, event, geocache site, city, country, or other area of interest to one or more users. The venue can be determined by a mobile device in communication with a server system and verified by a user of the mobile device to ensure the venue is properly associated with the user's preferred location. For example, the user's preferred location may pertain to a location from which the user wishes to author and upload communication content. The user may wish to provide a meaningful or a preferred “upload venue” to, for example, indicate to content readers that he is blogging, texting, or otherwise uploading communication content from his mobile device at a current location. The current location may relate to an actual geographic location or a user-influenced selected location.

A user of a mobile device can open an application program, such as a web browser, a chatting application, a blogging application, a micro-blogging application, etc., to upload communication content. Upon opening the single application, the mobile device may suggest or comment about a venue by determining any or all of the user's actual geographic location, a user's approximate geographic location, a previous user-selected location, a popular location, or an online user-voted location, just to name a few examples. In some examples, a location-aware application on the mobile device can detect specific user location information and deduce a possible preferred upload venue from the user's actual location. The mobile device can, in effect, recommend to the user a single venue as a selectable upload venue within the graphical user interface (GUI) of the open micro-blogging application, for example. Upon providing the venue or location recommendation, or concurrent with providing the recommendation, the mobile device may prompt the user to confirm the location. For example, the mobile device may determine an approximate geographic location of the user and determine, in cooperation with a computerized server system, a suggested venue at which the user (and the mobile device) may be located. The user can confirm the recommended venue, and any post or uploaded communication content associated with the confirmed venue may provide the venue (e.g., data identifying the venue) in the communication content when posted.

The mobile device can additionally provide the user with the capability of seeing posts related to particular preferred locations, which can modify device location information pertaining to any or all location-aware applications within the mobile device, regardless of the actual geographic location of the mobile device. For example, the user may identify either (i) a preferred location, or (ii) the user's current geographic location for posting content for other users to view.

In effect, the mobile device can allow the user to set a home venue location or another venue location that will be location-stamped on each post corresponding to the user selected location or venue. The mobile device can also use the selected location to retrieve location or venue data for places around the selected location. In some examples, the user may wish to “phantom blog” from a different venue or location than the user's current geographic location. For example, the user may be sitting in a coffee shop near a park and may prefer to attach the park venue rather than the coffee shop venue to any content posted. In this case, the mobile device may allow the user to select a location for stamping a communication in a blog posting or micro-blog posting, for example.

Further, applications on the mobile device may use the selected location as a basis for suggesting or providing user comments about other location based information to the mobile device user. For example, if the user is operating the mobile device in Burbank, Calif., and has recently returned from a vacation in New York City, N.Y., the mobile device can provide the user the option to toggle between CA and NY locations when both posting information and searching for other information related to either location. More particularly, if the user is uploading pictures from the NY vacation and discussing venues in the pictures, the mobile device can “guess” that the user wishes to post vacation-related communication and pictures as if the user were still traveling in NY to ensure, for example, the content looks “real time” to readers of the content. This can provide the user an advantage of creating a post or content about the vacation at a time other than when the user is experiencing the events. If the user wishes to have posts stamped with the CA location, the mobile device can provide that option as well, thereby allowing the user to toggle between both locations for posting.

FIGS. 1C-1D illustrate a presentation and selection of a suggested location of a mobile device 100A running a micro-blogging application. In some implementations when using the micro-blogging application, the mobile device 100A may require a user to register the micro-blogging application with a micro-blogging service. Once registered, the user can begin posting content using the micro-blogging application on the mobile device 100A. One example registration process may include establishing a user ID and password such that secure access to the micro-blogging application can be provided. In some implementations, once established by the micro-blogging service, the application may enable the user to log into an online blogging account and begin posting content for other users who may read and respond to the content. In some implementations, the user ID and password may pertain to a previously established email account, which may allow the user to begin using the micro-blogging application without direct registration if, for example, an email program were to integrate the micro-blogging application.

The user may use the mobile device 100A to submit content to a micro-blogging service or other web service. The submitted content can be posted to a website, sent in email, a text message, a voice message, a video message, or otherwise provided in an online manner to one or more users. For example, a user can open a micro-blogging program such as a “Buzz” application 102A shown in FIG. 1C, or another blogging or micro-blogging application and enter content for online submission.

The application 102A may include input fields and controls for a user to enter textual posts and access other online and offline information. In one example, the application 102A includes a text area 104A, a prompt area 106A, and a post configuration area 108A. The text area 104A provides a text editor that users can access to post content about ideas, news, events, conversation, opinions, or other musings. In some examples, a post entered in area 104A may be associated with a location of the user's mobile device at the time of post creation. For example, the user may opt to associate a location with their post including a latitude and longitude, current city or geographic region, commercial business, or venue and display the associated location as a venue of posting.

The prompt area 106A may represent a toolbar with a single location. The location may represent a venue selected by the mobile device 100A using a GPS secured location, a cellular service secured location, a triangulated location, a nearby location, a previously entered location, a popular location within a particular range of the user, or any combination of the above, for example.

The prompt area 106A may provide the user with a prompt 110A for selecting displayed location information. For example, the prompt area 106A includes an address, “1 Infinite Loop, Cupertino, Calif.” and a prompt 110A “At Apple Inc? Tap here” that the user can select. The prompt 110A may provide an estimated guess of a user's location with directions or prompting for the user to select an associated location or name of the address. For example, if the user's geographic location is near “1 Infinite Loop, Cupertino, Calif.,” the mobile device 100A may use location data to infer that the user wishes to provide a posting from the venue “Apple, Inc.” and may prompt the user to select Apple, Inc. using the question mark and the “Tap here” language.

In the depicted example in FIG. 1C, the prompt area 106A is a floating toolbar where the user can select a location for posting user-entered content. In some implementations, the prompt area 106A may be a toolbar which appears from a corner panel, a side panel, or a menu pop-up screen. In some implementations, the prompt area 106A may simply display a single location until a user hovers over the area 106A, at which point the prompt 110A may appear. In some implementations, the prompt area 106A may be a docked tool bar or a menu item.

The prompt area 106A may be provided as a single toolbar or graphic element within the micro-blogging application. This can provide a user of the micro-blogging application with a non-intrusive element in the micro-blogging user interface. In some examples, the toolbar may be provided upon hover over a graphic, a link, a menu item, a post, or other element within the micro-blogging application.

The prompt area 106A also includes a scroll control 112A to enable a user to scroll multiple selectable locations for posting. For example, if a user selects the scroll control 112A, another single location may be provided to the user in place of the Apple, Inc. location. The next location may be another “guessed” location of a venue, according to known user location or user entered data. For example, the next location may be a popular venue close to Apple, Inc, such as a coffee shop, a park, a mall, or other venue. In some implementations, the prompt area 106A may provide a single suggested venue and may not display other selectable venue options. In some implementations, the prompt area 106A may provide multiple address options, but only provide the prompt 110A on the first option.

Any number of locations may be scrollable using scroll control 112A. Providing a single location within prompt area 106A may provide the advantage of displaying a small or shrunken control for selecting locations since the user may be accessing the micro-blogging application on a portable device with a small display window. At some point, the user may close prompt area 106A by selecting a close control 114A. Other mechanisms may be available to close the area 106A. For example, the user may swipe (e.g., side-to-side or top-to-bottom motion) the prompt area 106A off of the screen using a fingertip or stylus to do so.

The post configuration area 108A may include configuration options for the user to configure post content and post attributes. For example, area 108A provides the user an option to make a post public or private by selecting either a public control 116A or a private control 118A, respectively.

In operation, users can open application 102A, enter content in text area 104A, and select a presented location from prompt area 106A. The user can then select a post control 120A to submit the entered content as a post entered from the user-selected location of posting. The posts may be transmitted from the mobile device to a central server where the content is disseminated to computing devices of other people. These other people may view the posts by using the same micro-blogging application, using email, or using another application, or by logging into a website that displays a stream of posts by other people that use the micro-blogging service.

Upon selecting a presented location and the prompt 110A, the micro-blogging application may display a selected location 122A in the toolbar 106A, as shown in FIG. 1D. The prompt 110A and the address may disappear. In this example, the selected location 122A may be associated with user content that the user enters as a post. If the user desires to change the location after selecting a location in prompt area 106A, the user can select the scroll control 112A to view other location options one at a time within area 106A.

If the user does not wish to be associated with a location, the user can close the toolbar 106A and continue posting without a location. In some implementations, the application defaults to a user's GPS triangulated location upon the closing of toolbar 106A.

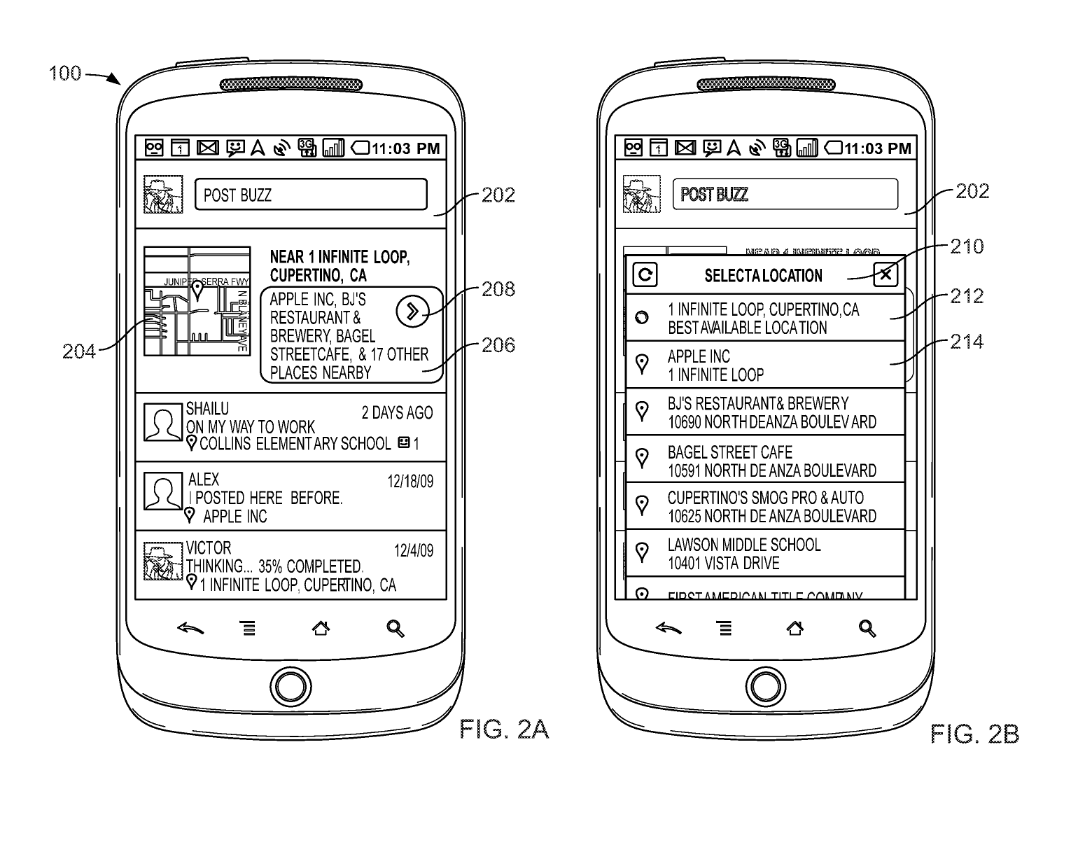

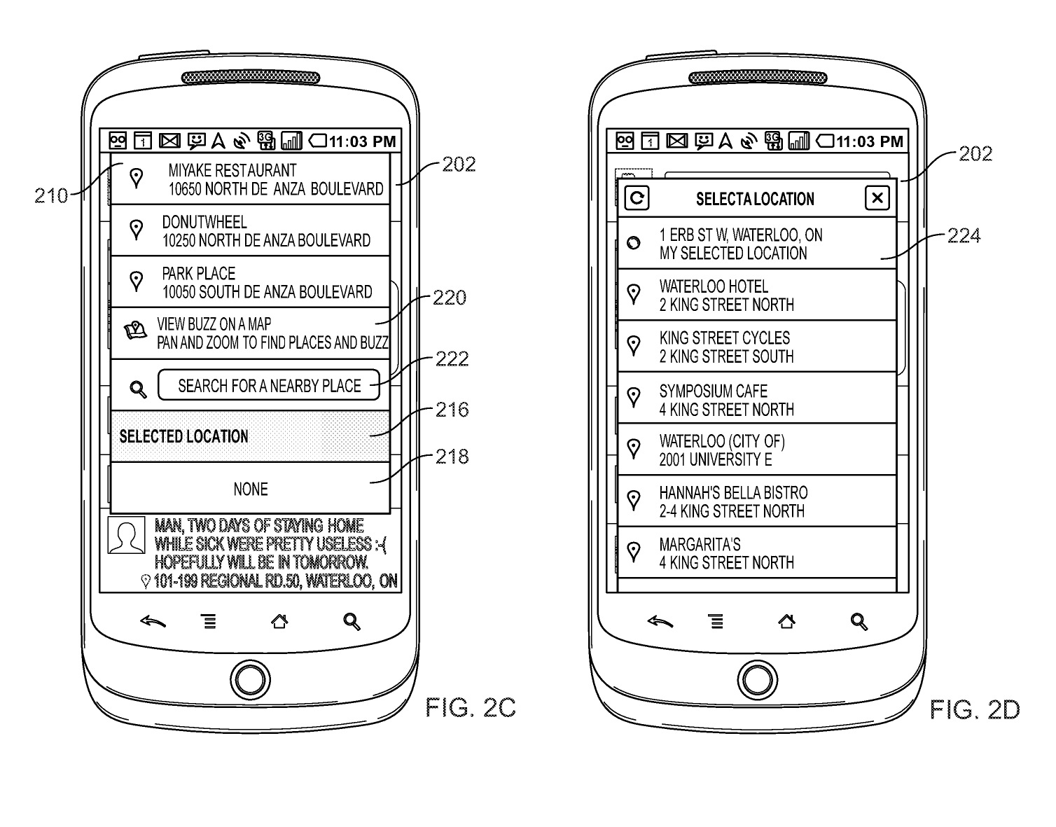

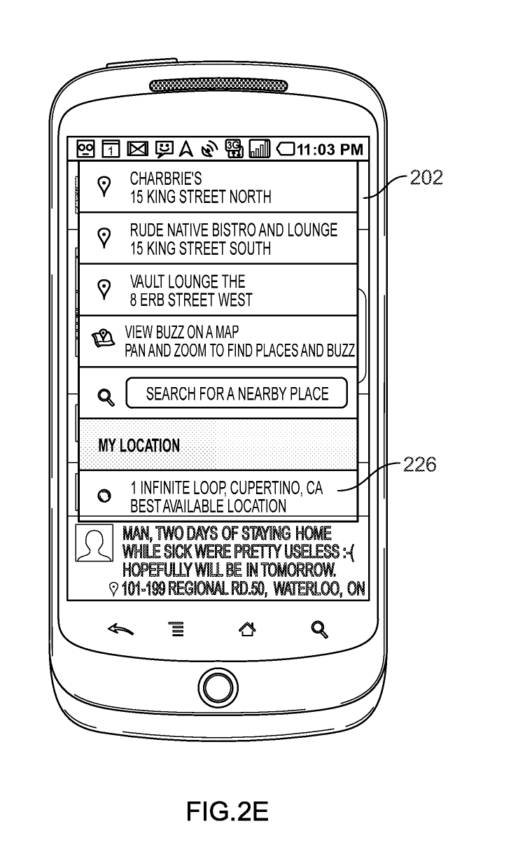

FIGS. 2A-2E illustrate a selection of a location of the mobile device 100. The content shown in FIGS. 2A-2E may be presented on a touch screen enabled device or other device capable of displaying content and receiving user input.

FIG. 2A shows an example display of an environment in which a user can access a micro-blogging application 202. The depicted application screen details one of several possible screens within micro-blogging application 202 and users can switch seamlessly between screens by selecting interface elements using any combination of taps, slides, menu selections, etc. In this example, several users have posted content for a user to view. For example, user “Shailu Chauhan” posted “On my way to work” from a venue named, “Collins Elementary School.” The user accessing the application 202 is shown a map 204 with his current geographic location and a list of venues in toolbar 206 near his current geographic location.

As shown, the user is near the street address “1 Infinite Loop, Cupertino, Calif.,” which the mobile device may have retrieved from the device location system, for example, in conjunction with communication with a server system. If the user selected the CA address in a previous screen, the venue may be noted as “Apple, Inc.” instead of the full address. The user can click on the toolbar 206 to view more information about the venues and/or locations in the list. For example, the user can select a control 208 to view the user's current location combined with other nearby location information, as shown in FIG. 2B.

FIG. 2B shows the micro-blogging application 202 with an overlaid extended toolbar 210. The toolbar 210 shows the user's current geographic location 212, an optional user-selected location 214, and other locations near the user's geographic location.

In some implementations, a mobile device running application 202 can receive location data by initiating a webpage of a mapping site. In some implementations, the running application 202 can initiate another application to determine location data. If the application 202 initiates a mapping application, messages can be sent between the application 202 and the mapping application to, for example, narrow down a list of locations to a single location. In this fashion, the mapping application can send GPS coordinates or latitude and longitude coordinates to the application 202. The application can use the received coordinates as a basis for finding other venues. Other data can be sent between applications to determine an appropriate location suggestion for application 202.

FIG. 2C shows the micro-blogging application 202 with the toolbar 210. The toolbar 210 can be used to allow the user to jump between two location contexts in the same interface. Here, the user is provided with even more locations around the user's current geographic location. The user can select any of the locations in FIG. 2B or 2C to set a selected location 216. In the depicted example of FIG. 2C, no location has been selected and thus, the selected location 216 is “none,” as shown in field 218.

In this illustration, the user can select a “view buzz on a map” tool 220 to pan and zoom to find a location from which to post content. Upon selecting the map tool 220, a map can be presented and the user can use the map to select a location. In addition, the user can search for a nearby place using search tool 222. The map or search tool 222 can be used to select a location. For example, the user can select a location on the map, and the application will return to the toolbar 210 with the selected location. The toolbar 210 may then display the user's selected location in field 218.

Upon selecting a location, the context of the location is changed and accordingly, searches or content entered into the application 202 may be performed in the context of the newly selected location. In addition, other locations listed with the selected location may be associated with the new context. In other words, upon selecting a new location context, the application 202 can repopulate other locations with locations that are near or within a specific range of the newly selected location. For example, all the locations that are displayed between the user's current geographic location interface element 212 and the user's selected location interface element 218 may be associated with one of the locations 218 or 212, depending on which location context is invoked.

FIG. 2D shows a user selected location 224 at a top of the toolbar 210 (e.g., indicating that a current context of the application program is associated with the user selected location 224). The other locations are now shown as having the location context of the user-selected location 224. The user can select another location in the list to view information about that location. In some implementations, the user can choose to promote one of the locations in the list to his selected location.

In operation of the micro-blogging application, the user can switch between a selected location and a geographic location which can, for example, change the context that the mobile device uses to associate location information to application content, such as micro-blogging posts. If the user wishes to switch from the selected location to a geographic location, the user can simply select the geographic location from the list of locations. Similarly, if the user would prefer to use another location, the user can select any other location in the list to set his selected location 224. In some implementations, the user can open the map tool to find other locations to set as a selected location.

In general, the application 202 enables the user to store two distinct location contexts with which to associate to particular applications. For example, the micro-blogging application 202 may be associated with a selected location while a browser window may be associated with a geographic location. As such, when the user posts using the micro-blogging application, the location associated and possibly displayed with the posts may be his selected location. When the user performs search queries for nearby restaurants in the browser, the geographic location may be used.

FIG. 2E shows the toolbar with the user's current geographic location 226 is unselected. Here, the user's selected location is used by the application 202 as a present location context rather than the geographic location 226. If the user prefers using the geographic location, the user can select the geographic location 226 to do so. In this case, the geographic location 226 may move to the top of the list of locations, while the selected location (e.g., location 224) moves to the bottom of the list. Accordingly, at any point when a user modifies a preferred location, the list of locations in-between a geographic location and a selected location may automatically change to accommodate the new location context. Namely, the new locations provided are nearby or associated with the preferred location, where the preferred location changes according to user input.

As an example, if a user is waiting to board a train traveling from his current location (e.g., Cupertino, Calif.) to Waterloo, ON, the user can be surfing the web and/or posting content as if the user were actually in Waterloo, ON at the time of surfing and posting. Here, the user can find nearby venues from the new location (e.g., Waterloo, ON) without having to be at the selected location. In operation, the user can open a map, select Waterloo, ON, and provide a post as if the user were already in Waterloo, ON.

Users can select any location based on interest and modify what the micro-blogging application 202 perceives to be its current location. Therefore, it is possible to phantom post content from a location based on easily selectable locations within an application. In addition, users can post a message from one location and post the next message from a second location without exiting the application or opening another application on the mobile device 100. Upon selecting or changing a location, the user can close the toolbar 210 and continue posting and reading posts within application 202.

The application 202 stores two location contexts, each of which can be selected by the application 202 to suggest nearby venues. Any number of venues may be displayed to the user. Each venue may be ranked and provided to the user in a ranked order.

Overlay Postings on a Map

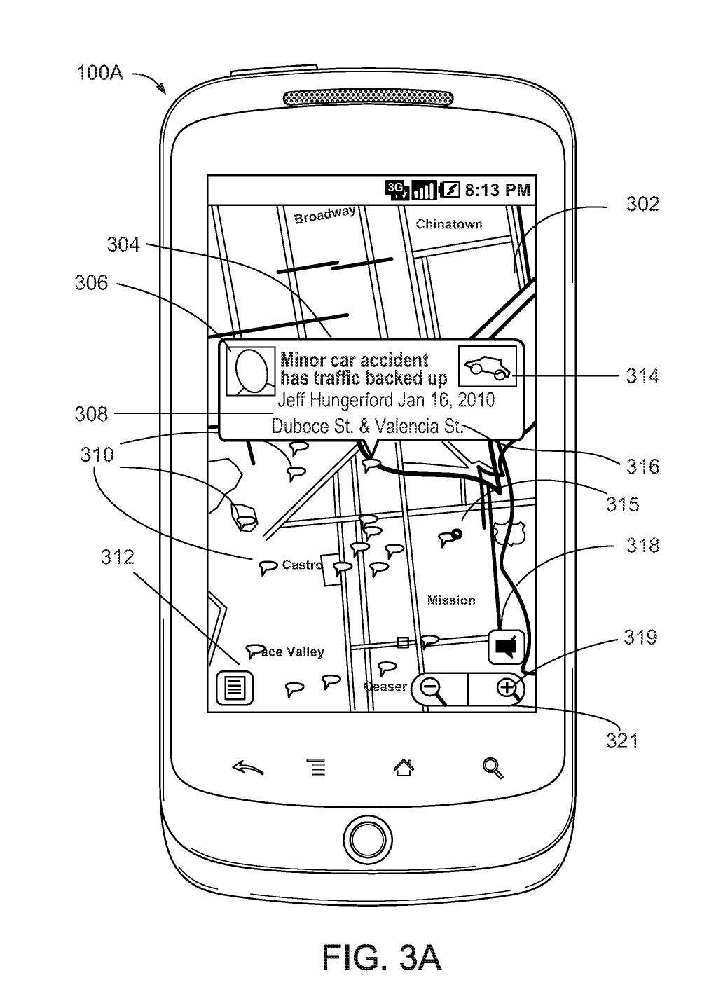

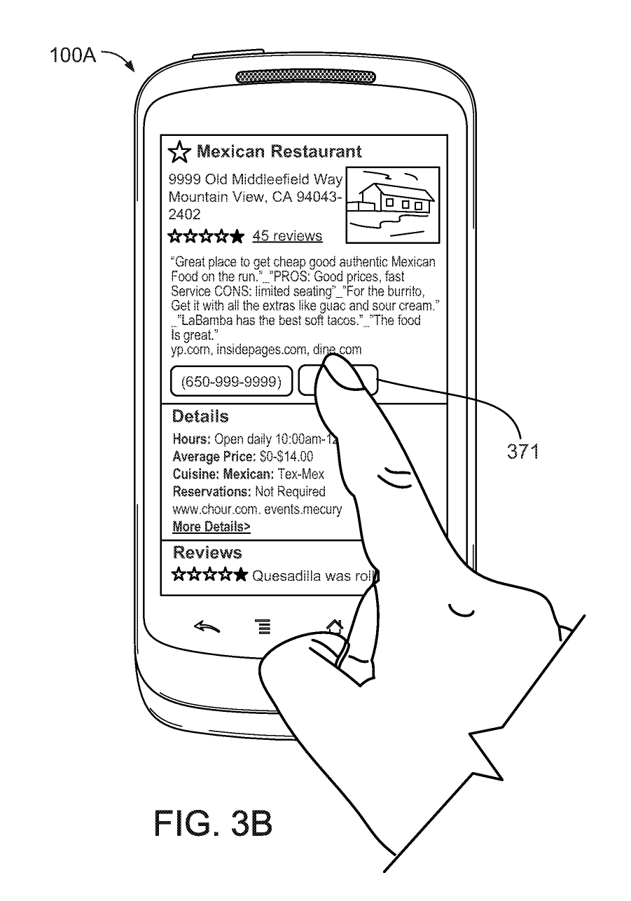

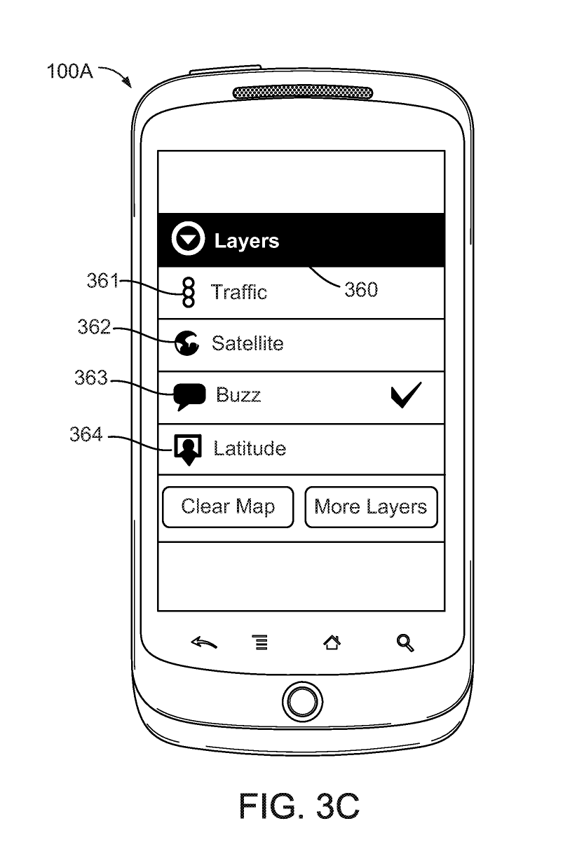

FIG. 3A is an illustration of posted comments (e.g., buzzes) about one or more locations presented on the mobile device. A mobile device, such as mobile device 100A can be used to present multiple posts for multiple locations on a map. In this example, a map 302 showing venues to the mobile device user. The map 302 depicts a number of user locations where one or more comment bubble icons 310 or chat bubbles representing one or more user posts are located on the map 302. The comment bubble icon 310 can be presented as a selectable icon on the mobile device 100A. Users can publish short messages, with text and optional photographs, and affix these messages to a location on the map 302. The mobile device 100A also shows posted message information 304 (e.g., an “infobubble”) from a user 308, who can post their picture 306, which may be on their user profile. The mobile device 100A also shows a picture 314 of a location or venue, such as a scene of an accident near an intersection of two streets. The user identification (ID) 308 can be presented, as well as the date of the message 316. In some implementations, the time of the posting is also presented to the user. The postings can be made in real time, and new comment bubble icons 310 may appear on the map 302 in real time.

The mobile device 100A may also show a composite icon 319 (presented here as a “+” zoom-in icon) that, when selected, takes the user to another screen that may be a full-screen view of a list of the currently-posted messages in that “zoomed” area of the map 302. The non-composite icon 321 (presented here as a “−” zoom out icon) is presented so that the current view in the map can be zoomed out to a larger area when the non-composite icon 321 is selected. There is also a list view icon 312, which can be selected to take the user to a screen (e.g., a full screen view) of a list of the posted messages in an area of the map 302. In some implementations, the posted message content presented on the map 302 may be presented according to the recency of the message, where older messages (e.g., messages older than 24 hours or another predetermined time period) will not be presented. The posted message content presented on the map 302 may depend upon other factors and signals. The message content that is posted may be determined on the server side. There is also a “nearby tab” 318 to present to the user messages that were posted nearby to the user's location.

The location can be encoded as either a reverse geocode of the latitude and longitude of the user's location when the user is posting the message. In some implementations, the location may be an actual physical place or venue associated with the user's location if the user chooses to specify it. For example, the user may specify that they are located at a particular restaurant or coffee shop, where the name of the venue can be presented. In some implementations, a user can also be presented with a list of venues in their geographic area, and the user can select a particular venue from that list as their location for the posting.

The comment bubble icons 310 may be presented in a layer over the map 302 (e.g., a “Buzz” layer over the map 302). In some embodiments, the layer may refer to metadata that can be overlaid (sometimes selectively overlaid) on one or more graphical representations, such as the map 302. There may be multiple different types of layers for the user to view on the map 302, such as a layer showing traffic on the streets on the map 302.

In some implementations, as the user travels with the mobile device 100A, several locations with comment bubble icons 310 may come into view and other locations with comment bubble icons 310 may go out of view. For example, new comment bubble icons 310 may appear when the user becomes physically located near a post office, a coffee shop, a city hall, a river park, or a parking ramp. As the user travels around streets and buildings, the mobile device 100A also can track the user and modify the surroundings and viewpoints on the map 302. The user has the option to turn off or turn on (e.g., toggle) the layer showing the comment bubble icons 310. Comment bubble icons 310 can also appear and disappear on the map 302 as the user moves or pans the map 302.

In some implementations, some comments bubbles, such as comment bubble icon 311, have a camera icon associated with the comment bubble icon to indicate that the posted message information includes a picture, such as the picture 314 of the accident scene. As shown in FIG. 3A, the posted message information 304 may show textual content, an optional photo 314, a user ID 308 and (thumbnail) picture 306, a date stamp and a location of the posting, in which information presented in the posted message information 304 may be selectable, and may reveal more information when selected. For example, by selecting the posted message information 304, the user can be taken to a full-screen conversation view of the message where any other comments may be presented.

In some implementations, there is a limit of the number of characters in the posted message information 304, and in other implementations, there is no limit of the number of characters in the posted message information 304. In some implementations, the posted message information 304 may be snapped or attached to a particular venue on the map 302 if a user manually moves the posted message information 304 close to that venue on the map 302.

In some embodiments, multiple users may present posted messages at the same venue and multiple comment bubble icons may be stacked on top of one another to correspond with those multiple postings. In other embodiments, information for a single posted message can be presented, and if a user selects that single posted message information then the user can be shown another page that lists all of the multiple postings. In some implementations, the user can view a list of posted messages around an area of the map or the posted messages may be indexed by venues. The list of posted messages or index of venues may have links to other messages or further detail on the venues, such as location and hours of operation. In some implementations, users may be able to see posted messages on a venue by selecting a venue on the map or on another page, such as an email page or associated application.

There may be other users that can comment on a posted message, then the other users can be added to a list of users to have posted messages on the venue, and those users may be sent an email message to notify them that a new post has been made about the venue. In some implementations, the user may be able to post a video clip instead of or in addition to a picture 314. In some implementations, the mobile device 100A may be a computer laptop instead of only a handheld-type mobile device.

In some implementations, a user may be able to search for specific posted messages at a venue. For example, if a user is at a concert venue and if there are hundreds of users there posting messages about the concert, then the users may be able to search for certain postings. For example, a user may be able to search for recent postings on the best places to park at the concert venue.

In some implementations, a user may be able to select an area on the map 302 to see if there is any posted message information 304 in that area of the map 302, and if so, can view all available posted messages in that area. The user can then optionally subscribe to forward or respond to the posted messages, or to compose new messages for posting to other mobile device users on the system.

FIGS. 3B-3C show illustrations involving posted comments associated with the venue. FIG. 3B shows an example where the mobile device 100A presents a “venue” page, which provides a selectable list of one or more venues to the user. One or more of the venues may have a selectable list of posted message information associated with the venue to show recent message postings for the selected venue.

In the venue page of FIG. 3B, a user can submit a post that is tied to the particular venue. A user of the mobile device 100A can scroll down on the venue page and select an input box 371 for posting a message (e.g., a buzz) that would automatically be snapped to the location of the venue in the map.

FIG. 3C shows a layer page 360 on that the mobile device 100A, where the layer page 360 includes a traffic layer 361, a satellite layer 362, a buzz layer 363 (e.g., a posted comment layer) and a latitude layer 364. Any of the layers 361, 362, 363, 364 can be toggled on or off to show the one or more layers 361, 362, 363, 364. Other layers may be presented as well, and some layers may overlay other layers in a particular order.

In some implementations, there can be a layer showing the posted messages (e.g., buzzes), and other layers that show the venues. In some of these implementations, a user can select a comment bubble icon on a map to open a presentation of posted message information. The posted message information can provide a path or link to an associated venue page, in which the user can view all of the posts for a particular venue.

Some implementations may include selectable venue icons on the map, where a user selection of a venue icon can lead to opening a presentation of posted message information associated with the selected venue. By selecting the posted information associated with the selected venue, a user can view the venue page and may proceed to view all posts for the particular venue. The selectable venue icons may also be in a venue layer on the map.

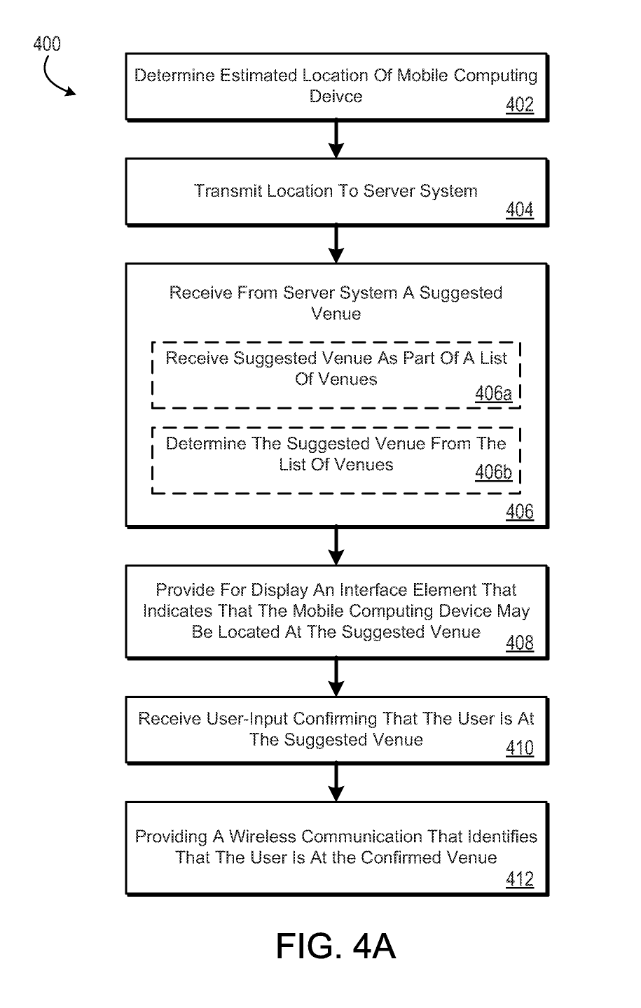

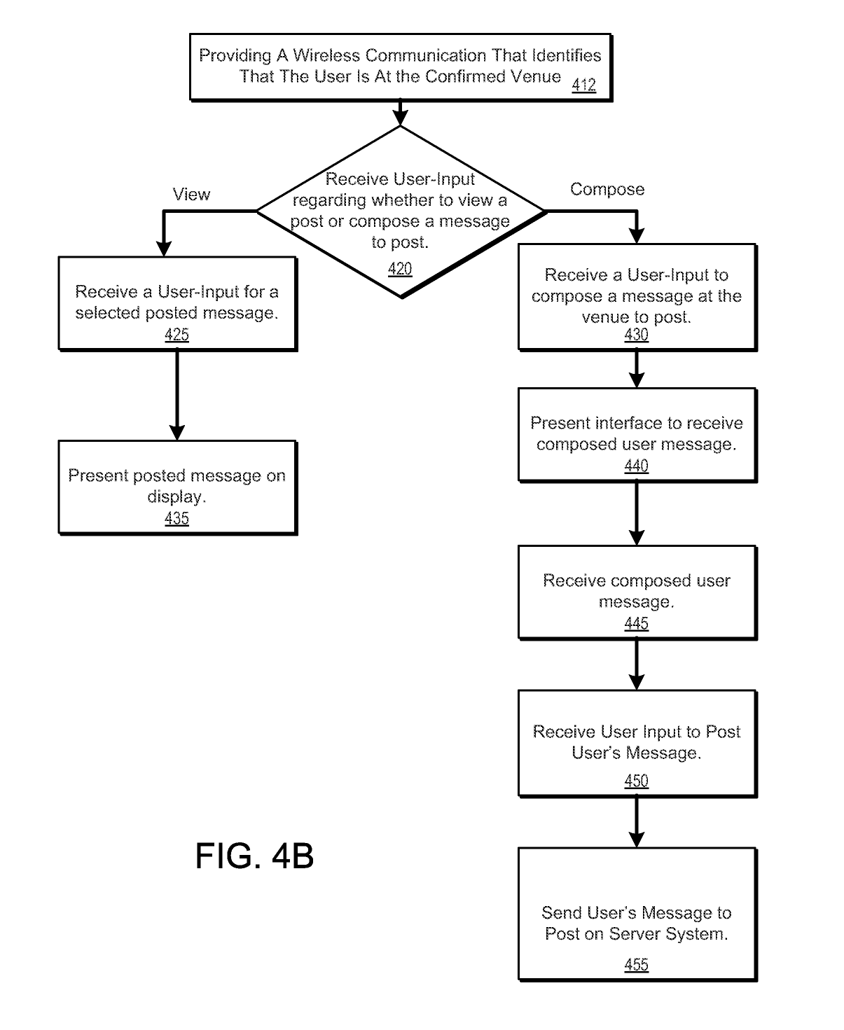

FIG. 4A is a flowchart of an example process 400 for verifying a venue associated with a user location. The process 400 can be performed, for example, by systems such as those described in association with FIGS. 1A-1D, 2A-2E, and 6.

In box 402, an estimated location of a mobile computing device is determined. In one example, the estimated location of the mobile computing device can be determined by the device itself. The estimated location may pertain to a geographic location of the mobile computing device. For example, the mobile device may employ GPS signals, cellular signals, or other location tracking signals with time stamps and coordinates to determine its location.

In box 404, the determined location is transmitted to a server system. For example, the mobile device 100A can send its location information to a micro-blogging server system.

In box 406, a suggested venue is received from the server system. The suggested venue can be determined by the server system. The server system can determine a list of venues and send a single venue or a ranked list of venues without a score, for example. In optional box 406a, the suggested venue is received as part of a list of venues. In optional box 406b, the venue is determined from the list of venues. For example, the mobile device 100A can use a first venue in the list as the suggested venue, or select another venue in the list based on other criteria.

In box 408, an interface element that indicates that the mobile computing device may be located at the suggested venue is provided for display. For example, the mobile device 100A can display the suggested venue in the prompt area 106.

In box 410, user input confirming that the user is at the suggested venue is received. For example, the mobile device 100A can receive a user input indicating that the user is indeed at the suggested location (e.g., by tapping the prompt area 106). In some implementations, the user can confirm location based on the desire to be perceived as located at the suggested venue. For example, the user may wish to have content location-stamped with the suggested venue upon posting content in the micro-blogging application.

In box 412, a wireless communication that identifies that the user is at the confirmed venue is provided. Here, the wireless communication is sent as a post by the user and the suggested venue is attached and displayed as an attribute of the post.

FIG. 4B is a flowchart of an example process for receiving or sending a posting of a message. From box 412, a wireless communication identifies that the user is at the confirmed venue. In box 420, a user input is received regarding whether to view a post of a message or to compose a message to post. If a user input is received for viewing a post of the message in box 425, the posted message is presented to the user on the display of the mobile device inbox 435. This posted message may be presented as the posted message information 304 (e.g., an “infobubble”) of FIG. 3, for example.

If a user input is received to compose a message at the venue to post in box 430, then an interface is presented to the user to receive a composed user message in box 440. In box 445, the interface receives the message that the user composed. In box 450, a user input is received to post the user's message to the server system so that other users of the system can view and access the user's posted message. In box 455, the user's message is sent to the server system for posting.

Overlaying Postings on Other Types of Views

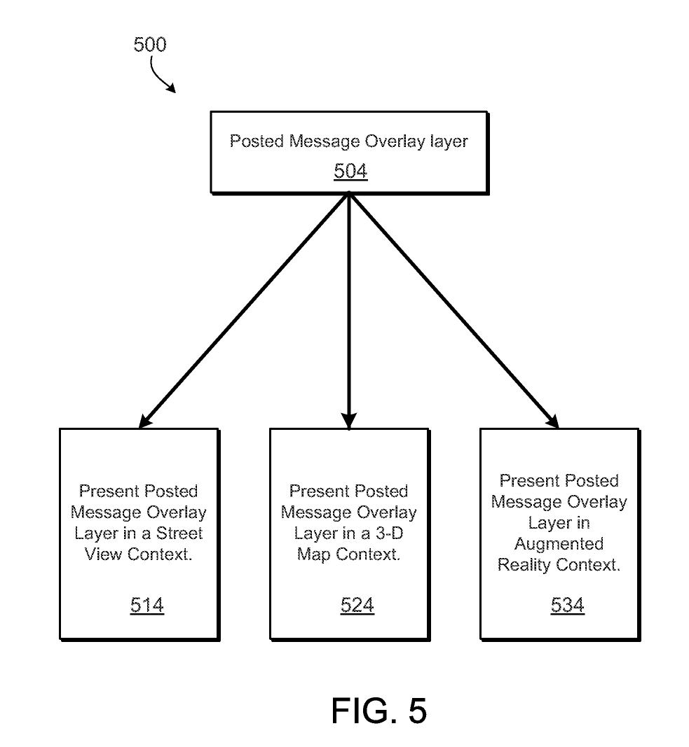

FIG. 5 is a flowchart of an example diagram 500 illustrating other types of postings using the layer of the message overlay. In some implementations, the posted messages can be overlaid on a street view in a street view context 514, or a three-dimensional (3-D) map rendering in a 3-D context 524, such as in a navigation application, or even a real-time view, such as in an augmented reality context 534. The augmented reality context may refer to the area located around the user, where the user can capture and depict in their camera. Some postings may be shown in an augmented reality context 534 where, instead of showing a map beneath the layer of posted messages as in FIG. 3, a camera view can be shown beneath the layer of posted messages. The camera view may be a heads-up display, for example.

The street view context 514 may present a view where the user may not be currently located. For example, the user may be located in Raleigh, N.C., and the street view that they are concerned about may be an intersection in Charlotte, N.C., and the user can see posted messages within the intersection Charlotte on their device located in Raleigh, N.C.

In a 3-D map rendering context 524, such as in a navigation application, the user can see real-time posted messages presented on a 3-D map rendering as the user moves, walks, or drives down a street or highway. The posted messages (e.g., represented as bubble icons) can appear and disappear with the location of the user as the user moves to other locations, changes angles, or viewpoints.

In some embodiments, the user may be able to send a two-dimensional (2-D) layer to overlay in the 3-D context. For example, the user may be able to use a mobile device, such as a cell phone that has a camera, and point the camera at a venue (e.g., a café or store) and the display on the cell phone can present a layer of comment bubble icons representing posted message information on the venues presented in the display. The cell phone user can then select the posted message information to see the messages posted by various users.

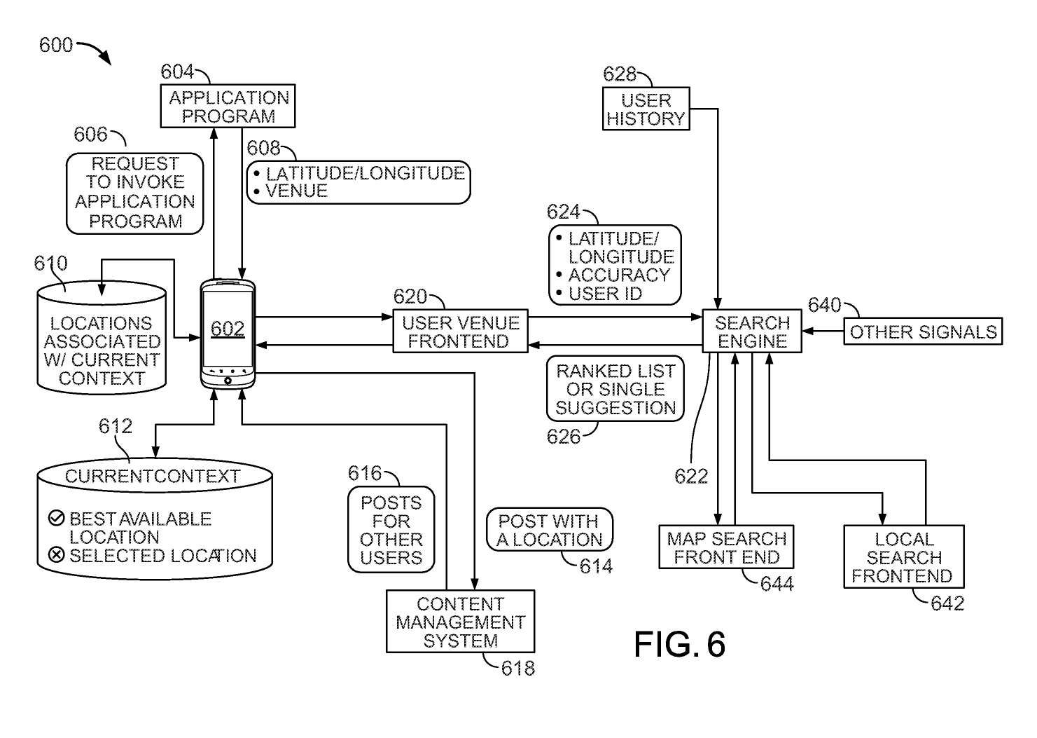

FIG. 6 is a diagram of an example system 600 for the postings. In this example, a user is operating one or more application programs 604 on the mobile device 602. Example application programs may include messaging applications (e.g., TWITTER, FACEBOOK, MYSPACE, LINKED IN, XING, etc.), mapping programs (GOOGLE MAPS, MAPQUEST, proprietary mapping software, etc.), search engines, game programs, email programs, text messaging programs, etc. The mobile device 602 can request 606 to invoke application programs 604 at the request of a user, for example.

The application programs 604 may be executed on the mobile device 602 and may provide location information, user data, and other data to the mobile device 602. For example, the application programs 604 may provide latitude and longitude data and/or venue data 608 to the mobile device 602. An application program 604 may send location or venue data 608 in two different ways. In a first example, one application (e.g., a maps application) “starts” another application (e.g., a micro-blogging application) by loading the other application as a web page, either separately or embedded in the maps application. To start the application, a URL may be provided to the web page browser. The URL may include location context information (e.g., http://www.google.com/application?ll=24.12345,−30.9876). In a second example, the other application is loaded by the first one, as described above, but “messages” may be transmitted between both applications. One or more of these messages may include the location or venue data 608.

The mobile device 602 may include a location-identification unit to determine the location of the device and thus the location of the user. The mobile device 602 may include a screen to (i) display a single suggested venue on a display of the mobile computing device with a prompt for a user to confirm whether or not the user is located at the venue, and (ii) receive user input confirming that the user is located at the venue.

The mobile device 602 may also include a screen to display (i) an indication of the current location, (ii) indications of venues that are relevant to the current location, and (iii) an interface element for changing the current location to the other of the estimated geographic location and user-identified location.

The mobile device 602 can store data pertaining to users and user locations. For example, the device 602 may store locations associated with a current location context 610. In another example, the mobile device 602 can store current contexts 612, such as the best available location and a user selected location.

Users can post content using mobile device 602. For example, users can create textual, video, and/or audio content and the device 602 can post the content 614 with a particular location. The location may pertain to current context 612. Users may also consume posts 616 from other users using mobile device 602. In some implementations, a content management system 618 may manage content which is sent and received by each mobile device in use in a social network, for example.

The mobile device 602 can employ a user venue front end 620 to send and receive information to and from a search engine 622. The user venue front end 620 may send information 624 including, but not limited to latitude and longitude data, accuracy data, and user identification data to the search engine 622. The information 624 can be used to properly employ contextual location data selections. In some examples, the information 624 can ensure that the search engine 622 provides users with venue data tailored for each individual user.

The search engine 622 can use various signals to determine and suggest relevant lists of location data to users. The signals may include user history 628 and other signals 640.

User history signals 628 may represent a history of received user confirmations where users have selected particular locations (either particular to a user of mobile device 602 or generally for multiple users of the micro-blogging service). User history signals 628 may also represent location data for places from which a user often visits or posts content. In some implementations, user history signals 628 may represent a previous location on an ongoing itinerary.

The search engine 622 can employ a local search front end 642 to retrieve signals for determining relevant lists of location data. The local search front end 642 may retrieve popular venue information near particular locations. In some implementations, search ranking information can be used to rank location venues. The search engine 622 can employ a map search front end 644 to retrieve signals for determining relevant lists of location data. The map search front end 644 may provide map query data entered by users. In some examples, the map search front end 644 or the local search front end 642 provide the ranked list of suggested venues or single suggested venue 622 to the search engine 622, and the signals 628, 640 are used by the map or local search front ends 642 and 644 to generate a list or single suggested venue 626.

In operation, the mobile device 602 can send data to the user venue front end 620. The user venue front end 620 can forward the data to the search engine 622. The search engine 622 can send suggested locations, locations of interest, or switched location information to the user venue front end 620, which can send the information (in a ranked manner) to the mobile device 602 for consumption by the user.

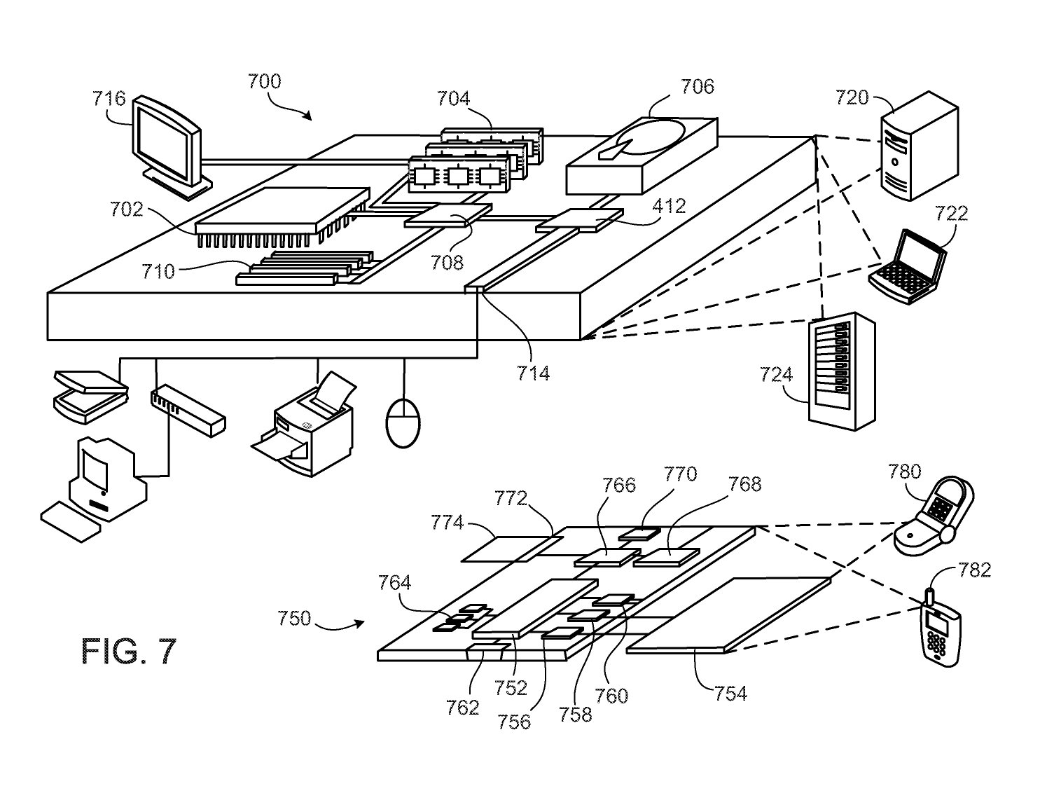

FIG. 7 is a diagram of computing devices 700, 750 that may be used to implement the systems and methods described in this document, as either a client or as a server or plurality of servers. Computing device 700 is intended to represent various forms of digital computers, such as laptops, desktops, workstations, personal digital assistants, servers, blade servers, mainframes, and other appropriate computers. Computing device 750 is intended to represent various forms of mobile devices, such as personal digital assistants, cellular telephones, smart phones, and other similar computing devices. Additionally computing device 700 or 750 can include Universal Serial Bus (USB) flash drives. The USB flash drives may store operating systems and other applications. The USB flash drives can include input/output components, such as a wireless transmitter or USB connector that may be inserted into a USB port of another computing device. The components shown here, their connections and relationships, and their functions, are meant to be exemplary only, and are not meant to limit implementations described in and/or shown from this document.

Computing device 700 includes a processor 702, memory 704, a storage device 706, a high-speed interface 708 connecting to memory 704 and high-speed expansion ports 710, and a low speed interface 712 connecting to low speed bus 714 and storage device 706. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high speed interface 708. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 704 stores information within the computing device 700. In one implementation, the memory 704 is a volatile memory unit or units. In another implementation, the memory 704 is a non-volatile memory unit or units. The memory 704 may also be another form of computer-readable medium, such as a magnetic or optical disk.

The storage device 706 is capable of providing mass storage for the computing device 700. In one implementation, the storage device 706 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 704, the storage device 706, or memory on processor 702.

The high speed controller 708 manages bandwidth-intensive operations for the computing device 700, while the low speed controller 712 manages lower bandwidth-intensive operations. Such allocation of functions is exemplary only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, an input/output device such as a display 754, a communication interface 766, and a transceiver 768, among other components. The device 750 may also be provided with a storage device, such as a microdrive or other device, to provide additional storage. Each of the components 750, 752, 764, 754, 766, and 768, are interconnected using various buses, and several of the components may be mounted on a common motherboard or in other manners as appropriate.

The processor 752 can execute instructions within the computing device 750, including instructions stored in the memory 764. The processor may be implemented as a chipset of chips that include separate and multiple analog and digital processors. Additionally, the processor may be implemented using any of a number of architectures. For example, the processor 710 may be a CISC (Complex Instruction Set Computers) processor, a RISC (Reduced Instruction Set Computer) processor, or a MISC (Minimal Instruction Set Computer) processor. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT (Thin-Film-Transistor Liquid Crystal Display) display or an OLED (Organic Light Emitting Diode) display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may be provide in communication with processor 752, so as to enable near area communication of device 750 with other devices. External interface 762 may provide, for example, for wired communication in some implementations, or for wireless communication in other implementations, and multiple interfaces may also be used.

The memory 764 stores information within the computing device 750. The memory 764 can be implemented as one or more of a computer-readable medium or media, a volatile memory unit or units, or a non-volatile memory unit or units. Expansion memory 774 may also be provided and connected to device 750 through expansion interface 772, which may include, for example, a SIMM (Single In Line Memory Module) card interface. Such expansion memory 774 may provide extra storage space for device 750, or may also store applications or other information for device 750. Specifically, expansion memory 774 may include instructions to carry out or supplement the processes described above, and may include secure information also. Thus, for example, expansion memory 774 may be provide as a security module for device 750, and may be programmed with instructions that permit secure use of device 750. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, or memory on processor 752 that may be received, for example, over transceiver 768 or external interface 762.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, WiFi, or other such transceiver (not shown). In addition, GPS (Global Positioning System) receiver module 770 may provide additional navigation- and location-related wireless data to device 750, which may be used as appropriate by applications running on device 750.

Device 750 may also communicate audibly using audio codec 760, which may receive spoken information from a user and convert it to usable digital information. Audio codec 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in a number of different forms, as shown in the figure. For example, it may be implemented as a cellular telephone 780. It may also be implemented as part of a Smartphone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions or data.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), peer-to-peer networks (having ad-hoc or static members), grid computing infrastructures, and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. Moreover, other mechanisms for confirming a venue of user location and switching between location contexts may be used. In addition, the logic flows depicted in the figures do not require the particular order shown, or sequential order, to achieve desirable results. Other steps may be provided, or steps may be eliminated, from the described flows, and other components may be added to, or removed from, the described systems. Accordingly, other implementations are within the scope of the following list of claims.

What is claimed is:

1. A computer-implemented method for real-time messages associated with a user location, the method comprising:
determining, by a mobile computing device, an estimated geographic location of the mobile computing device;
receiving, at the mobile computing device, one or more messages associated with an area around the estimated geographic location, wherein the one or more messages comprise messages posted by users of a system that associates messages that those users posted about the area around the estimated geographic location; and
providing, on a display of the mobile computing device, one or more posted message icons that are presented together in a layer over a map, wherein the one or more posted message icons represent the one or more posted messages.

2. The computer-implemented method of claim 1, further comprising accessing data for an area comprising a venue, a business, a street, or an address.

3. The computer-implemented method of claim 1, further comprising receiving a user input of a selection of one of the posted message icons to present information associated with the posted message associated with the posted message icon, and obtaining the information about the posted message from a server system.

4. The computer-implemented method of claim 3, further comprising, in response to receiving the user input of the selection of the posted message icon, presenting the information for the posted message.

5. The computer-implemented method of claim 4, further comprising accessing the information for the posted message comprising a user text message, a user identification (ID), and at least one of a time of the posting of the message or a day of the posting of the message.

6. The computer-implemented method of claim 4, further comprising accessing the information for the posted message comprising a picture corresponding to the user identification (ID).

7. The computer-implemented method of claim 4, further comprising accessing the information for the posted message comprising a user-provided picture.

8. The computer-implemented method of claim 1, further comprising posting the one or more posted message icons that are presented in the layer over the map within a predetermined time period of their respective postings.

9. The computer-implemented method of claim 8, wherein the predetermined time period comprises 24 hours, and the method further comprises removing the one or more posted message icons from the layer over the map after the predetermined time period expires.

10. The computer-implemented method of claim 1, further comprising presenting a selectable icon that, when selected, presents a selectable list of the one or more posted messages.

11. The computer-implemented method of claim 1, further comprising:
receiving a user input, at the mobile computing device, for composing a message to post to at least one other user;
receiving, at the mobile computing device, the composed message to post; and
posting, from the mobile computing device, the composed message to a server system.

12. A computer-implemented method for managing real-time messages associated with a user location, the method comprising:
receiving, at a mobile computing device, one or more messages associated with an area within a geographic location, wherein the one or more messages comprise messages posted by users of a system that associates messages that those users posted about an area within a geographic location;
providing, on a display of the mobile computing device, one or more posted message icons that are presented in a layer over another layer in the display, wherein the one or more posted message icons represent the one or more posted messages;
receiving, at the mobile computing device, a user input of a selection of one of the posted message icons to present information associated with the posted message associated with the posted message icon; and
presenting, on the mobile computing device, the information associated with the posted message on the display of the mobile computing device.

13. The computer-implemented method of claim 12, further comprising accessing information for the other layer comprising a venue layer, a satellite layer, a map, a two-dimensional rendering of the area, a three-dimensional rendering of the area, a street view layer, or an augmented reality layer.

14. The computer-implemented method of claim 13, further comprising:
configuring at least one of the other layers to be overlaid on top of at least one of the other layers; and
configuring one or more of the other layers to be toggled on or off by a user selection on the mobile computing device.

15. The computer-implemented method of claim 13, further comprising receiving user input on the mobile computing device to subscribe to compose a message for posting.

16. The computer-implemented method of claim 13, further comprising:
receiving user input on the mobile computing device to present a list of venues; and
based upon the receiving user input for the list of venues, presenting a list of venues on the mobile computing device.

17. The computer-implemented method of claim 16, further comprising:
receiving user input on the mobile computing device to present information associated with one or more posted messages of a selected venue in the list of venues; and
based upon receiving the user input for the venue selection, presenting the information associated with the one or more posted messages of the selected venue.

18. The computer-implemented method of claim 13, wherein the information associated with the posted message on the display of the mobile computing device comprises venue information, and the method further comprises:
receiving a user input, at the mobile computing device, regarding the venue information; and
presenting the venue information in an interface on the mobile computing device.

19. The computer-implemented method of claim 18, wherein the presented venue information comprises a list of posted messages associated with the venue.

20. The computer-implemented method of claim 19, wherein one or more of the posted messages in the list of posted messages are deleted from the list if the posted message has been listed over a predetermined amount of time.

21. The computer-implemented method of claim 19, wherein a new posted message appears in the list of posted messages when a subscriber of the system posts the new posted message.

22. A system for real-time messages associated a user location, the system comprising:
a mobile computing device configured to:
receive one or more messages associated with an area within an estimated geographic location, wherein the one or more messages comprise messages posted by users of the system to associate messages that those users posted about the area within the estimated geographic location; and
provide one or more posted message icons that are presented in a layer over a map, wherein the one or more posted message icons represent the one or more posted messages; and
a location-identification unit to determine the estimated geographic location of the mobile computing device; and
a server to receive the estimated geographic location and forward the one or more posted messages associated with the area to the mobile computing device.
